(19) United States
(12) Patent Application Publication
(10) Pub. No.: US 2025/0266773 A1
(43) Pub. Date: Aug. 21, 2025

(54) VOLTAGE REGULATOR INDUCTOR

(71) Applicants: Pavan Kumar, Portland, OR (US); Justin Tippetts, Hillsboro, OR (US)

(72) Inventors: Pavan Kumar, Portland, OR (US); Justin Tippetts, Hillsboro, OR (US)

(21) Appl. No.: 19/059,980

(22) Filed: Feb. 21, 2025

Related U.S. Application Data
(60) Provisional application No. 63/556,281, filed on Feb. 21, 2024.

(51) Int. Cl. H02M 5/10

(52) U.S. Cl. CPC H02M 5/10

(57) ABSTRACT

A method for configuring a voltage regulator (VR) inductor includes determining a compensation inductance of a compensation inductor in a secondary winding of the VR inductor. The method further includes determining leakage inductance in the secondary winding. The method further includes determining an equivalent inductance of the secondary winding based on the compensation inductance and the leakage inductance. The method further includes reconfiguring the secondary winding based on removing the compensation inductor, to obtain a reconfigured secondary winding. The method further includes adjusting a coupling coefficient between a primary winding of the VR inductor and the secondary winding to adjust the equivalent inductance. The adjusting of the coupling coefficient is based on the removing of the compensation inductor.

### PRIORITY APPLICATION

This application claims the benefit of priority to U.S. Provisional Application Ser. No. 63/556,281, filed Feb. 21, 2024, which is incorporated herein by reference in its entirety.

### BACKGROUND

Trans-inductor voltage regulators (TLVRs) are widely used in server platforms to meet stringent transient requirements. They provide faster transient response compared to traditional multi-phase buck VRs. However, TLVRs can be configured to occupy a significant footprint, which results in processing inefficiencies and higher production costs.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1A is a circuit representation of a multi-phase TLVR topology, in accordance with some embodiments;

FIG. 1B is a circuit representation of a multi-phase TLVR topology, in accordance with some embodiments;

FIG. 2 is a block diagram of a TLVR inductor combination in accordance with some embodiments;

FIG. 3A is a diagram of an equivalent circuit corresponding to the TLVR inductor combination of FIG. 2, in accordance with some embodiments;

FIG. 3B is a table of a coupling coefficient for the equivalent circuit of FIG. 3A, in accordance with some embodiments;

FIG. 4A is a diagram of an equivalent circuit corresponding to the multi-phase TLVR topology of FIG. 1A, where the secondary inductance includes leakage inductance and compensation inductance, in accordance with some embodiments;

FIG. 4B is a diagram of an equivalent circuit corresponding to the multi-phase TLVR topology of FIG. 1A, where the secondary inductance includes leakage inductance and no compensation inductance, in accordance with some embodiments;

FIG. 5 is a flow diagram of an example method for configuring a TLVR inductor, in accordance with some embodiments; and

FIG. 6 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “a processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

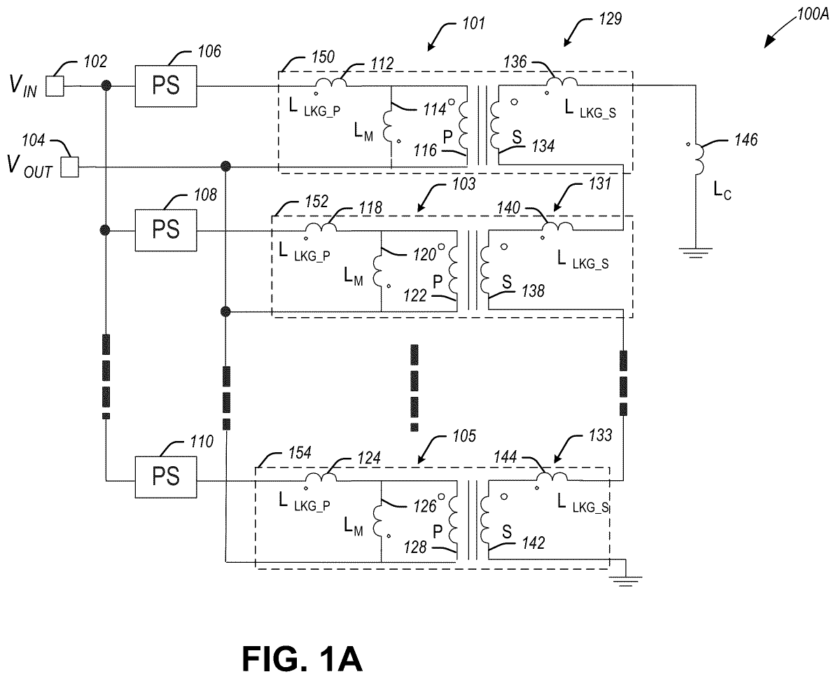

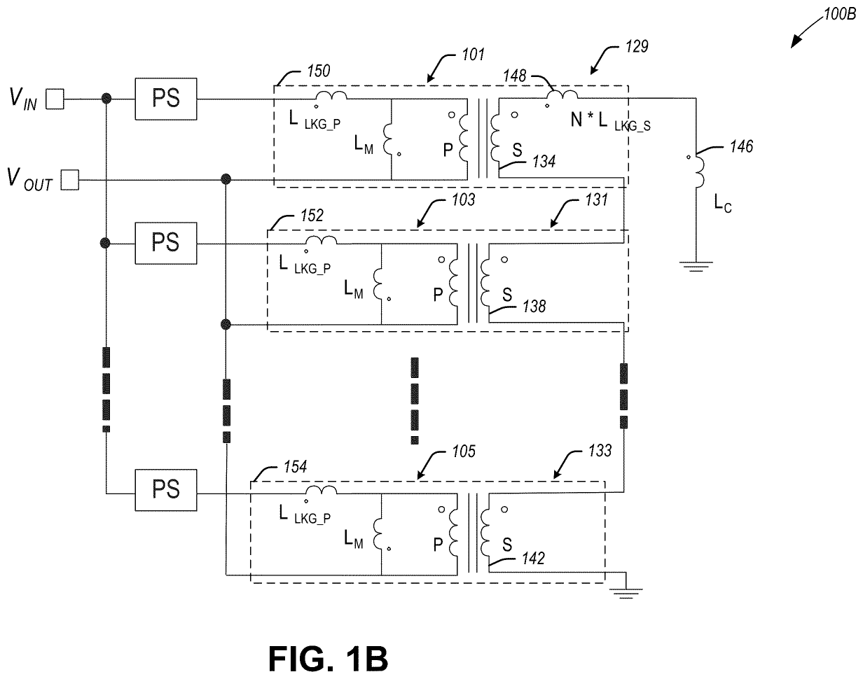

To achieve higher performance, the TLVR inductor can be designed like a transformer with primary and secondary windings. The topological constraints require the secondary of the TLVR inductors to be connected in series with a compensation inductor (Lc), as shown in FIG. 1A and FIG. 1B, where the primary and secondary leakage inductances of the TLVR inductor are also shown.

Even though the disclosed techniques are discussed in terms of TLVRs, the disclosure is not limited in this regard, and the disclosed techniques can be applicable to other types of inductors as well.

FIG. 1A is a circuit representation of a multi-phase TLVR topology 100A, in accordance with some embodiments. Referring to FIG. 1A, TLVR topology 100A includes an input voltage terminal 102, an output voltage terminal 104, and primary processing circuits 101, 103, . . . , 105 inductively coupled to corresponding secondary processing circuits 129, 131, . . . , 133. As illustrated in FIG. 1A, the primary processing circuits 101, 103, . . . , 105 are connected to each other in parallel, and the secondary processing circuits 129, 131, . . . , 133 are connected to each other in series.

A primary processing circuit and a secondary processing circuit form a TLVR inductor. For example, TLVR inductor 150 is formed by primary processing circuit 101 and secondary processing circuit 129. Similarly, TLVR inductor 152 is formed by primary processing circuit 103 and secondary processing circuit 131, and TLVR inductor 154 is formed by primary processing circuit 105 and secondary processing circuit 133.

Primary processing circuit 101 of TLVR inductor 150 includes a primary leakage inductance 112, a magnetizing inductance 114, and a primary winding 116.

Primary processing circuit 103 of TLVR inductor 152 includes a primary leakage inductance 118, a magnetizing inductance 120, and a primary winding 122.

Primary processing circuit 105 of TLVR inductor 154 includes a primary leakage inductance 124, a magnetizing inductance 126, and a primary winding 128.

In some aspects, each of the primary processing circuits also includes a power stage (PS). For example, primary processing circuit 101 includes power stage 106, primary processing circuit 103 includes power stage 108, and primary processing circuit 105 includes power stage 110.

Secondary processing circuit 129 includes a secondary winding 134, a secondary leakage inductance 136, and a compensation inductor 146 (also referred to as Lc).

Secondary processing circuit 131 includes a secondary winding 138 and a secondary leakage inductance 140.

Secondary processing circuit 133 includes a secondary winding 142 and a secondary leakage inductance 144.

Even though the TLVR topology 100A is illustrated as including multiple TLVR inductors (e.g., TLVR inductors 150, 152, . . . , 154, which can be N TLVR inductors), the disclosure is not limited in this regard. A TLVR topology can include a single TLVR inductor (or more TLVR inductors), where each TLVR inductor is configured based on the disclosed techniques.

FIG. 1B is a circuit representation of a multi-phase TLVR topology 100B, in accordance with some embodiments. Referring to FIG. 1B, TLVR topology 100B is the same as TLVR topology 100A except that secondary leakage inductances 136, 140, . . . , 144 are represented collectively by a single leakage inductance 148 in secondary processing circuit 129 of TLVR inductor 150.

The compensation inductor 146 can occupy an additional area in the TLVR topology layout. The cost and physical space of the LC inductor are additional overheads that need to be borne to achieve better topology performance. The disclosed techniques can include configuring the leakage inductance of a TLVR inductor as an alternative to the compensation inductor (Lc) to either reduce the size or eliminate the need for a compensation inductor.

The disclosed techniques include a TLVR inductor with a secondary processing circuit with controlled leakage inductance such that it can be used as a compensation inductor (Lc). More specifically, the disclosed techniques include configuring the TLVR inductor with a controlled leakage inductance such that the total inductance in the secondary winding of the TLVR topology is nearly equal to the total inductance in the secondary winding when a discrete compensation inductor is used. The disclosed techniques include increasing the leakage inductance of the TLVR inductor by adjusting the coupling coefficient (k) of the primary and secondary winding such that the effective inductance in the series connected secondary winding is nearly equal to the topology using a compensation inductor, which results in the elimination of the need for a discrete compensation inductor.

The disclosed techniques can include using the effective leakage inductance of the TLVR inductors connected in series in place of a discrete compensation inductor. The disclosed techniques also include configuring the leakage inductance of the TLVR inductor by controlling the coupling coefficient (k) between the primary and secondary windings of the TLVR inductor.

The disclosed TLVR configurations result in the following advantages:
(a) Reduced cost of the TLVR solution on the server platforms;
(b) Reduced space to implement the TLVR solutions; and
(c) Reduced space by eliminating the compensation inductor, which can be used to increase the power capability of the VR (e.g., by adding an additional phase to the VR).

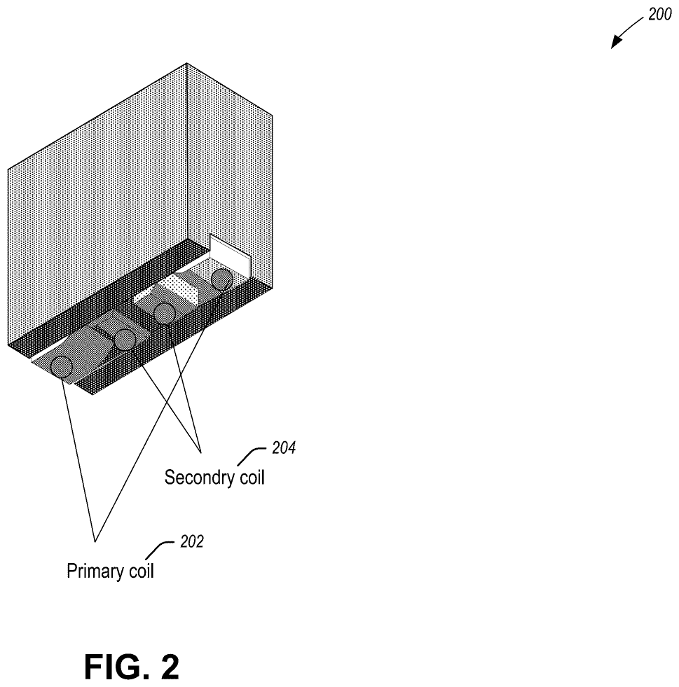

FIG. 2 is a block diagram of a TLVR inductor 200, in accordance with some embodiments. Referring to FIG. 2, TLVR inductor 200 can include a primary coil 202 (or a primary winding) and a secondary coil 204 (or a secondary winding). In some aspects, different configurations of the TLVR inductor 200 can be based on different configurations of the terminals of the primary coil 202 and the secondary coil 204 (e.g., different distances between the coil terminals or between the primary and secondary coil windings can result in different coupling coefficients).

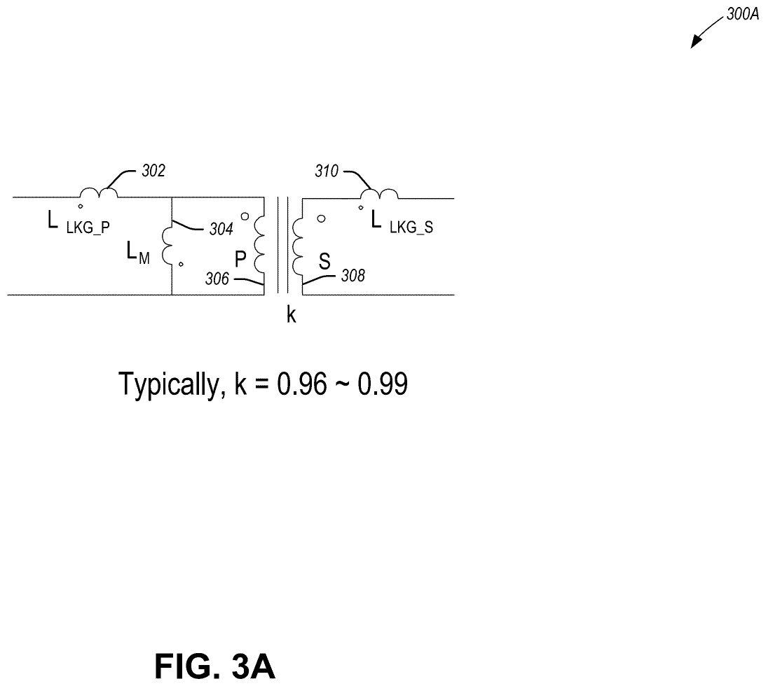

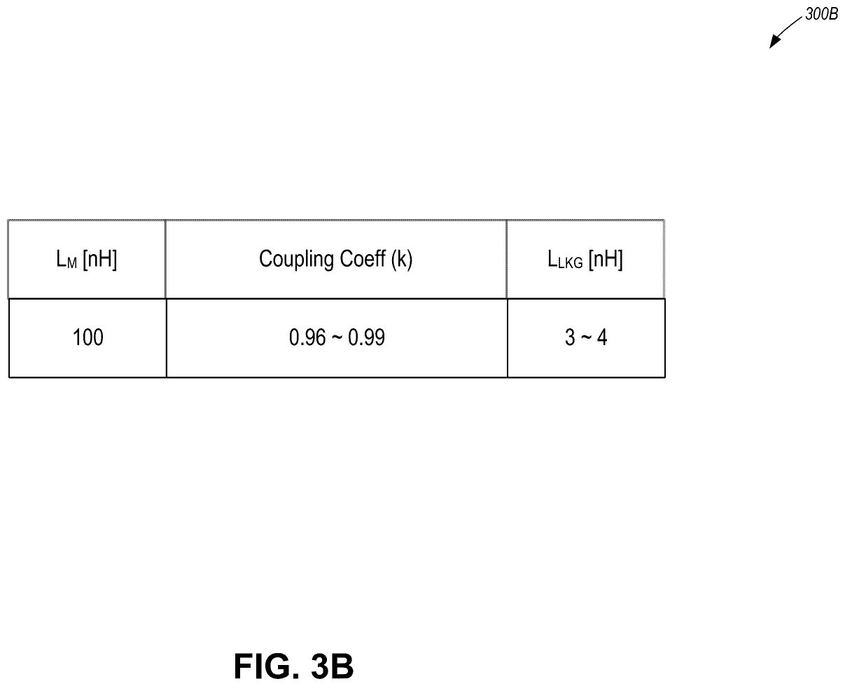

FIG. 3A is a diagram of an equivalent circuit 300A corresponding to the TLVR inductor combination of FIG. 2, in accordance with some embodiments. Referring to FIG. 3A, the equivalent circuit 300A includes a primary processing circuit formed by a primary leakage inductance 302, a magnetizing inductance 304, and a primary winding 306. The equivalent circuit 300A also includes a secondary processing circuit formed by a secondary leakage inductance 310 and a secondary winding 308, which is inductively coupled to primary winding 306.

FIG. 3B is a table 300B of a coupling coefficient for the equivalent circuit of FIG. 3A, in accordance with some embodiments. In some aspects, the coupling coefficient (k) has a value designed near to unity. It can be adjusted to a range of 0.96˜ 0.99, resulting in a leakage of around 3˜4% of the primary inductance. Hence, for a primary inductance of 100 nH, the primary and secondary leakage can be around 3˜ 4 nH.

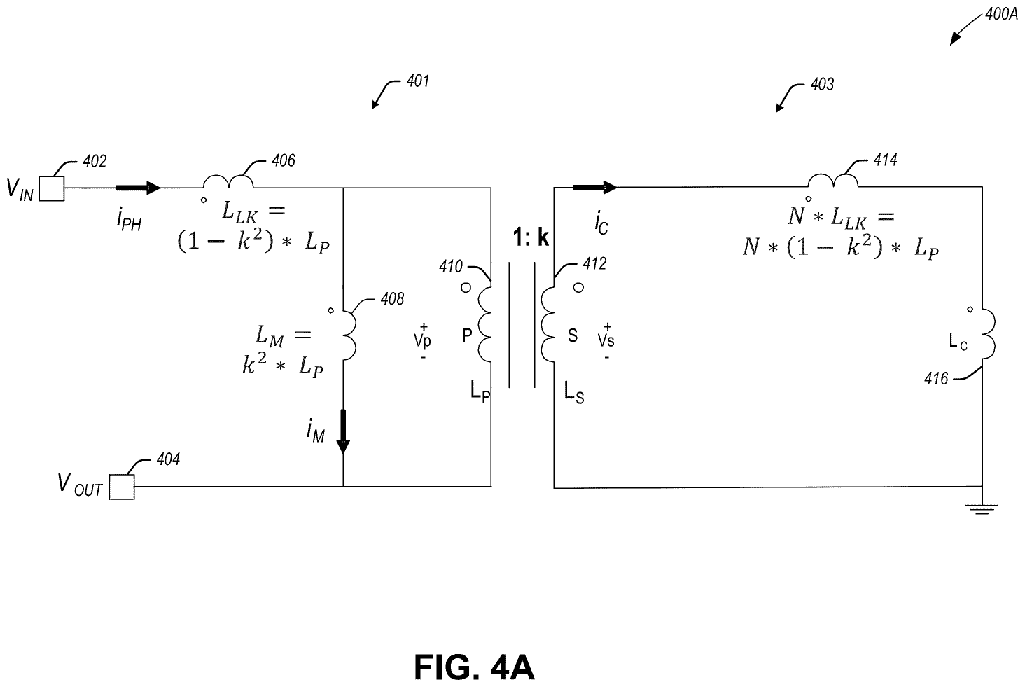

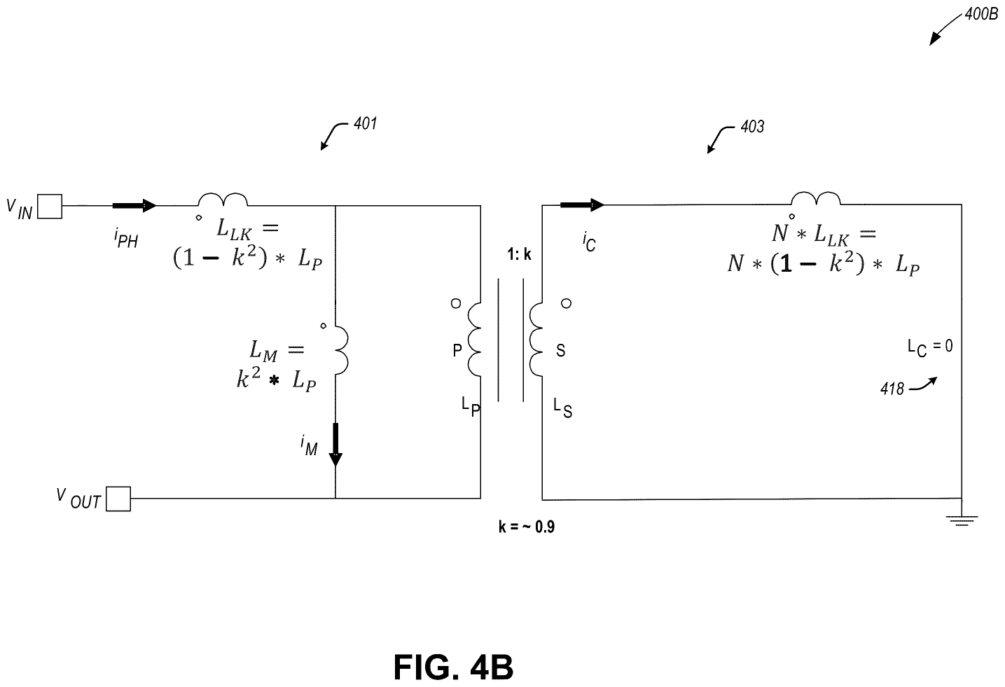

FIG. 4A is a diagram of a single-phase equivalent circuit corresponding to the multi-phase TLVR topology of FIG. 1A, where the secondary inductance includes leakage inductance and compensation inductance, in accordance with some embodiments. Referring to FIG. 4A, the equivalent circuit 400A includes an input voltage terminal 402, an output voltage terminal 404, and a primary processing circuit 401 inductively coupled to a secondary processing circuit 403.

The primary processing circuit 401 includes primary leakage inductance 406, magnetizing inductance 408, and primary inductance 410.

The secondary processing circuit 403 includes secondary inductance 412, secondary leakage inductance 414, and compensation inductance 416 (corresponding to compensation inductor 146 coupled to the secondary leakage inductance 136). Secondary leakage inductance 414 corresponds to the inductance of the serially coupled secondary leakage inductances 136, 140, . . . , 144.

FIG. 1A shows an N-phase TLVR topology with a discrete compensation inductor (Lc) connected in series with the secondary windings of the TLVR inductors. FIG. 4A shows the equivalent inductance (Leq) of the secondary winding, which is the combination of the N-phase leakage inductance and the compensation inductance (Lc).

The disclosed techniques can be used to design a new TLVR inductor with a lower coupling factor k such that the effective leakage inductance (both primary and secondary) is higher than the typical value. The increased leakage inductance on the secondary can then be used as the equivalent inductance with the compensation inductor being absent. Table 1 below shows the comparison of the traditional coupling coefficient and the corresponding inductor parameter to the proposed inductor with the new coupling coefficient.

TABLE 1
Coupling Factor and Leakage Inductance Characteristics
for Traditional and Disclosed TLVR Inductor

| | | | | Coupling | Leakage Inductance |
|---|---|---|---|---|---|
| | | Inductance | | Coeff | (LLK) |
| # | Detail | Coil | [nH] | k | [nH] |
| 1 | Traditional | Primary | 105 | 0.96~0.97 | 3.4~4.2 |
| | TLVR Inductor | Secondary | 105 | | |
| 2 | Disclosed | Primary | 100 | 0.9~0.92 | 14~16 |
| | TLVR Inductor | Secondary | 100 | | |

FIG. 4B is a diagram of an equivalent circuit corresponding to the multi-phase TLVR topology of FIG. 1A, where the secondary inductance includes leakage inductance and no compensation inductance, in accordance with the proposed embodiments. Referring to FIG. 4B, the equivalent circuit 400B is the same as equivalent circuit 400A except for the secondary processing circuit 403, which now includes an effective compensation inductance 418 equal to 0 (based on the compensation inductor 146 being removed from the secondary processing circuit 129 in the TLVR topology 100B).

The following configurations are associated with the equivalent circuit 400A of FIG. 4A:

$${L}_{P} = 100 nH ; {L}_{C} = 100 nH ; N = 5 ; \qquad ( a )$$

$$k = 0.96 ∼ 0.99 ; \qquad ( b )$$

$${L}_{LK} = ∼ 4 nH ; \qquad ( c )$$

$${L}_{EQ} = N * ( 1 - {k}^{2} ) * {L}_{P} + {L}_{C} ; and \qquad ( d )$$

$${L}_{EQ} = 5 * 4 nH + 100 nH = ∼ 120 nH . \qquad ( e )$$

The following configurations are associated with the equivalent circuit 400B of FIG. 4B after removal of the compensation inductor:

$${L}_{P} = 100 nH ; {L}_{C} = 0 ; N = 5 ; \qquad ( a )$$

$$k = ∼ 0.9 ; \qquad ( b )$$

$${L}_{LK} = ∼ 16 nH ; \qquad ( c )$$

$${L}_{EQ} = N * ( 1 - {k}^{2} ) * {L}_{P} + {L}_{C} ; and \qquad ( d )$$

$${L}_{EQ} = 5 * 16 nH + 0 = ∼ 80 nH . \qquad ( e )$$

In the above configurations, a phase system with N=5 is assumed. FIG. 4A is based on a TLVR implementation with a discrete compensation inductor (Lc=100 nH) with TLVR inductors having a coupling coefficient (k) near unity (0.97˜ 0.99). The resulting equivalent inductance (Leq) in the secondary winding is shown to be ˜ 120 nH.

FIG. 4B is based on a TLVR implementation with a TLVR inductor having a coupling coefficient near 0.9, which results in a leakage inductance of ˜ 16 nH. The equivalent secondary inductance (Leq) in this case will be near 80 nH with the elimination of the discrete compensation inductor (e.g., Lc=0). The 5-phase TLRV design can now be optimized for the appropriate equivalent secondary inductance while the additional Lc component is eliminated in the physical layout. The increased leakage inductance of the TLVR inductor now plays the role of providing the inductance needed in the secondary.

In this regard, if a compensation inductor is removed from a secondary processing circuit of a TLVR topology, the coupling coefficient (k) can be adjusted (e.g., based on adjusting the secondary leakage inductance) so that the new equivalent secondary inductance (Leq) in the new TLVR topology (without a compensation inductor) is substantially equal to (or being within a preconfigured threshold from) the prior equivalent secondary inductance in the prior TLVR topology (with a discrete compensation inductor present). In some aspects, the coupling coefficient can be adjusted until the new equivalent secondary inductance is within a threshold measurement of the prior equivalent secondary inductance.

In some aspects (e.g., when multiple serially connected secondary processing circuits are used in the TLVR topology), the adjustment to the secondary leakage inductance can be based on separate (individual) adjustments of the inductances of one or more of the secondary leakage inductances in the topology. For example, a leakage inductance adjustment can be based on adjusting leakage adjustment in a single TLVR inductor or multiple TLVR inductors.

In some aspects, a combination of a TLVR inductor with low leakage (k˜ 0.99) and the proposed TLVR high leakage inductor (k˜ 0.9 or less) can be used to tune the value of the equivalent secondary inductance (Leq) in a design to achieve the optimal performance in terms of efficiency, transient response, cost, and space.

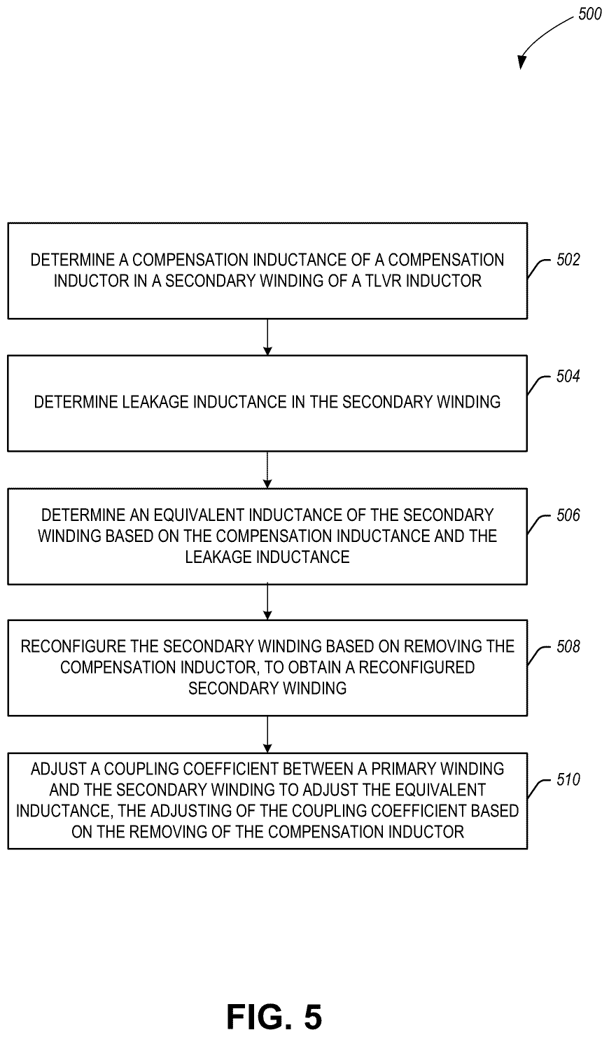

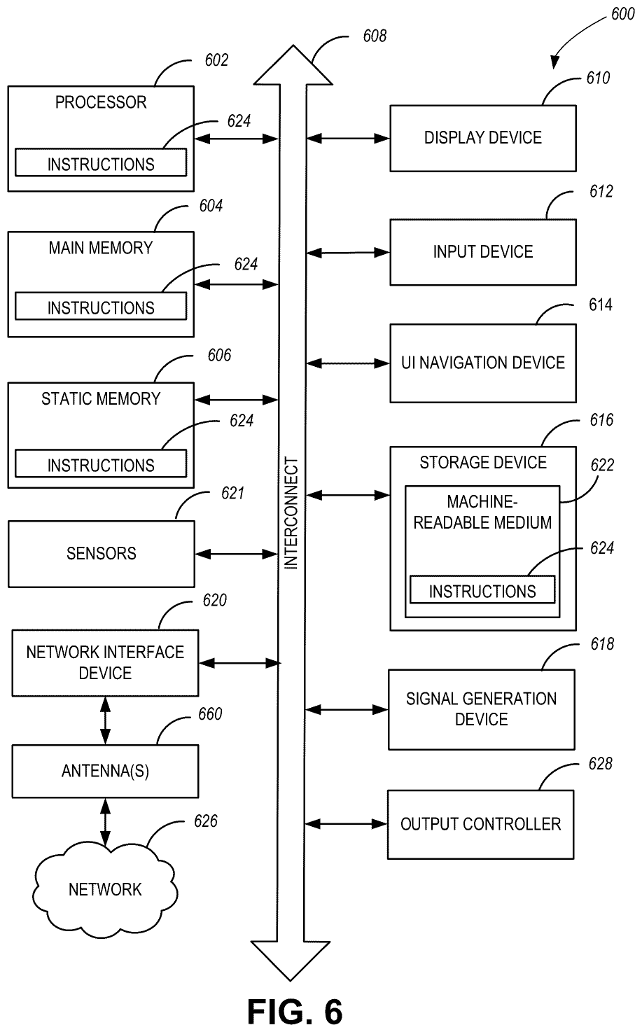

FIG. 5 is a flow diagram of an example method 500 for configuring a TLVR inductor, in accordance with some embodiments. Referring to FIG. 5, method 500 includes operations 502, 504, 506, 508, and 510, which may be executed by an embedded controller or another processor of a computing device (e.g., hardware processor 602 of machine 600 illustrated in FIG. 6, which can include one or more of the circuits discussed in connection with FIGS. 1A-4B). In some embodiments, one or more of the circuits discussed in connection with FIGS. 1A-4B can perform the functionalities listed in FIG. 5, as well as in the examples listed below.

At operation 502, a compensation inductance of a compensation inductor in a secondary winding of the TLVR inductor is determined.

At operation 504, a leakage inductance in the secondary winding is determined.

At operation 506, an equivalent inductance of the secondary winding is determined based on the compensation inductance and the leakage inductance.

At operation 508, the secondary winding is reconfigured based on removing the compensation inductor to obtain a reconfigured secondary winding.

At operation 510, a coupling coefficient between a primary winding of the TLVR inductor and the secondary winding is adjusted to change the equivalent inductance. The adjustment of the coupling coefficient is based on the removal of the compensation inductor.

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, machine 600 may operate in the capacity of a server machine, a client machine, or both in server-client network environments. In an example, machine 600 may function as a peer machine in a peer-to-peer (P2P) (or other distributed) network environment. The machine 600 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 600 may include a hardware processor 602 (e.g., a central processing unit (CPU), a graphics processing unit (GPU), a hardware processor core, or any combination thereof), a main memory 604, and a static memory 606, some or all of which may communicate with each other via an interlink (e.g., bus) 608. In some aspects, the main memory 604, the static memory 606, or any other type of memory (including cache memory) used by machine 600 can be configured based on the disclosed techniques or can implement the disclosed memory devices.

Specific examples of main memory 604 include Random Access Memory (RAM) and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 600 may further include a display device 610, an input device 612 (e.g., a keyboard), and a user interface (UI) navigation device 614 (e.g., a mouse). In an example, the display device 610, the input device 612, and the UI navigation device 614 may be a touchscreen display. The machine 600 may additionally include a storage device (e.g., drive unit or another mass storage device) 616, a signal generation device 618 (e.g., a speaker), a network interface device 620, and one or more sensors 621, such as a global positioning system (GPS) sensor, compass, accelerometer, or other sensors. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 602 and/or instructions 624 may comprise processing circuitry and/or transceiver circuitry.

The storage device 616 may include a machine-readable medium 622 on which one or more sets of data structures or instructions 624 (e.g., software) embodying or utilized by any one or more of the techniques or functions described herein can be stored. Instructions 624 may also reside, completely or at least partially, within the main memory 604, within static memory 606, or the hardware processor 602 during execution thereof by the machine 600. In an example, one or any combination of the hardware processor 602, the main memory 604, the static memory 606, or the storage device 616 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 622 is illustrated as a single medium, the term “machine-readable medium” may include a single medium or multiple media (e.g., a centralized or distributed database and/or associated caches and servers) configured to store instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, one or more sensors 621, a network interface device 620, one or more antennas 660, a display device 610, an input device 612, a UI navigation device 614, a storage device 616, instructions 624, a signal generation device 618, and an output controller 628. The apparatus may be configured to perform one or more of the methods and/or operations disclosed herein. The apparatus may be intended as a component of machine 600 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 600 and that causes machine 600 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 624 may further be transmitted or received over a communications network 626 using a transmission medium via the network interface device 620 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one single-input multiple-output (SIMO), multiple-input multiple-output (MIMO), or multiple-input single-output (MISO) techniques. In some examples, the network interface device 620 may wirelessly communicate using multiple-user MIMO techniques. The term “transmission medium” shall be taken to include any intangible medium that can store, encode, or carry instructions for execution by machine 600, including digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

A machine-readable medium may be provided by a storage device or other apparatus that is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (object code, binary executable code, etc.) on one or several remote servers.

In further examples, a software distribution platform (e.g., one or more servers and one or more storage devices) may be used to distribute software, such as the example instructions discussed above, to one or more devices, such as example processor platform(s) and/or example connected edge devices noted above. The example software distribution platform may be implemented by any computer server, data facility, cloud service, etc., capable of storing and transmitting software to other computing devices. In some examples, the providing entity is a developer, a seller, and/or a licensor of software, and the receiving entity may be consumers, users, retailers, OEMs, etc., that purchase and/or license the software for use and/or re-sale and/or sub-licensing.

In some examples, the instructions are stored in a particular format on storage devices of the software distribution platform. A format of computer readable instructions includes, but is not limited to, a particular code language (e.g., Java, JavaScript, Python, C, C#, SQL, HTML, etc.) and/or a particular code state (e.g., uncompiled code (e.g., ASCII), interpreted code, linked code, executable code (e.g., a binary), etc.). In some examples, the computer-readable instructions stored in the software distribution platform are in a first format when transmitted to an example processor platform(s). In some examples, the first format is an executable binary in which particular types of processor platform(s) can execute. However, in some examples, the first format is uncompiled code that requires one or more preparation tasks to transform the first format to a second format to enable execution on the example processor platform(s). For instance, the receiving processor platform(s) may need to compile the computer-readable instructions in the first format to generate executable code in a second format that is capable of being executed on the processor platform(s). In still other examples, the first format is interpreted code that, upon reaching the processor platform(s), is interpreted by an interpreter to facilitate the execution of instructions.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.

Example 1 is a voltage regulator (VR) apparatus (e.g., 100A) comprising an input voltage terminal coupled to a plurality of input terminals of a corresponding plurality of power stage circuits (e.g., 106, 108, . . . , 110); a plurality of VR inductors, a first terminal of each of the plurality of VR inductors coupled to an output terminal of a corresponding power stage circuit of the plurality of power stage circuits; and an output voltage terminal coupled to a second terminal of each of the plurality of VR inductors.

In Example 2, the subject matter of Example 1 includes subject matter where each VR inductor of the plurality of VR inductors comprises a primary leakage inductance comprising a first terminal coupled to the first terminal of the VR inductor.

In Example 3, the subject matter of Example 2 includes subject matter where each VR inductor of the plurality of VR inductors comprises a magnetizing inductance comprising a first terminal coupled to a second terminal of the primary leakage inductance and a second terminal coupled to the second terminal of the VR inductor.

In Example 4, the subject matter of Example 3 includes subject matter where each VR inductor of the plurality of VR inductors comprises a primary winding comprising a first terminal coupled to the second terminal of the primary leakage inductance and a second terminal coupled to the second terminal of the VR inductor.

In Example 5, the subject matter of Example 4 includes subject matter where each VR inductor of the plurality of VR inductors comprises a secondary winding comprising a first terminal coupled to a first terminal of a secondary leakage inductance.

In Example 6, the subject matter of Example 5 includes subject matter where a second terminal of the secondary winding is coupled in series with at least another secondary winding of at least another VR inductor of the plurality of VR inductors.

In Example 7, the subject matter of Example 6 includes the following: wherein the primary winding is coupled in parallel with at least another primary winding of at least another VR inductor of the plurality of VR inductors.

In Example 8, the subject matter of Example 7 includes a system-on-chip (SoC), the SoC comprising an integrated circuit (IC), the IC comprising at least one of the input voltage terminal, the output voltage terminal, and one or more of the plurality of VR inductors.

In Example 9, the subject matter of Example 8 includes subject matter where the SoC further comprises at least one connector and wherein the at least one connector conforms with at least one of a Universal Serial Bus (USB) specification, a High-Definition Multimedia Interface (HDMI) specification, a Thunderbolt specification, a Peripheral Component Interconnect Express (PCIe) specification, or an Ethernet specification.

Example 10 is a voltage regulator (VR) inductor, the VR inductor comprising: at least one primary winding; and at least one secondary winding inductively coupled to the at least one primary winding, the at least one secondary winding comprising leakage inductance, and one or both of the leakage inductance and a coupling coefficient of the VR inductor are configured based on an equivalent inductance of the at least another secondary winding when the at least one secondary winding includes, a compensation inductor.

In Example 11, the subject matter of Example 10 includes a first plurality of interconnects coupled to the at least one primary winding and a second plurality of interconnects coupled to the at least one secondary winding.

In Example 12, the subject matter of Example 11 includes subject matter where one or more of the first plurality of interconnects couple the at least one primary winding of the VR inductor in parallel with at least another primary winding of at least another VR inductor.

In Example 13, the subject matter of Example 12 includes subject matter where one or more of the second plurality of interconnects couple the at least one secondary winding of the VR inductor in series with at least another secondary winding of the at least another VR inductor.

In Example 14, the subject matter of Examples 10-13 includes subject matter where the coupling coefficient is configured to be below 0.95, and the leakage inductance is configured to be below 17 nH.

In Example 15, the subject matter of Examples 10-14 includes subject matter where the coupling coefficient is configured between 0.9 and 0.92, and the leakage inductance is configured between 14 and 17 nH.

Example 16 is a method for configuring a voltage regulator (VR) inductor, the method comprising determining a compensation inductance of a compensation inductor in a secondary winding of the VR inductor, determining leakage inductance in the secondary winding, determining an equivalent inductance of the secondary winding based on the compensation inductance and the leakage inductance; reconfiguring the secondary winding based on removing the compensation inductor, to obtain a reconfigured secondary winding, and adjusting a coupling coefficient between a primary winding of the VR inductor and the secondary winding to adjust the equivalent inductance, the adjusting of the coupling coefficient based on the removing of the compensation inductor.

In Example 17, the subject matter of Example 16 includes adjusting the coupling coefficient based on a desired equivalent inductance of the reconfigured secondary winding.

In Example 18, the subject matter of Examples 16-17 includes adjusting the coupling coefficient based on a desired equivalent inductance of the reconfigured secondary winding being substantially equal to the equivalent inductance of the secondary winding prior to the reconfiguring.

In Example 19, the subject matter of Examples 16-18 includes subject matter where the VR inductor comprises a plurality of secondary windings including the secondary winding, the plurality of secondary windings associated with a corresponding plurality of leakage inductances, and the method further comprising: adjusting the equivalent inductance further based on adjusting the leakage inductance of one or more of the plurality of leakage inductances.

In Example 20, the subject matter of Examples 16-19 includes subject matter where adjusting the equivalent inductance comprises adjusting the coupling coefficient to be below 0.95 and adjusting the leakage inductance to be below 17 nH.

Example 21 is a voltage regulator (VR) inductor comprising at least one primary winding and at least one secondary winding coupled to the at least one primary winding and configured based on techniques disclosed herein.

In Example 22, the subject matter of Example 21 includes at least one processor, the at least one processor including one or both of the at least one primary winding and the at least one secondary winding.

Example 23 is a method comprising a plurality of operations executed with a processor and memory, wherein the plurality of operations are configured in accordance with techniques discussed herein.

Example 24 is a non-transitory device-readable storage medium that includes instructions, wherein the instructions, when executed by a processing circuitry of a computing device, cause the processing circuitry to perform operations configured in accordance with techniques discussed herein.

Example 25 is an apparatus comprising respective means for implementing one or more of the techniques discussed herein.

Example 26 is a network comprising respective devices and device communication mediums for performing any of the operations or techniques discussed herein.

Example 27 is a system comprising respective components arranged or configured to perform any of the operations or techniques discussed herein.

Example 28 is a method performed using the circuitry of a computing device arranged or configured to perform any of the operations or techniques discussed herein.

Example 29 is a system-on-a-chip (SoC) including at least one TLVR inductor described herein.

Example 30 is a system comprising at least one inductor disclosed herein, a memory, and at least one processor coupled to the memory and the at least one inductor, the at least one processor configured to perform one or more configuration functions associated with the at least one inductor or cause communication of signaling associated with the at least one inductor.

Example 31 is a process of making a voltage regulator (VR) inductor, the process comprising determining a compensation inductance of a compensation inductor in a secondary winding of the VR inductor, determining leakage inductance in the secondary winding, determining an equivalent inductance of the secondary winding based on the compensation inductance and the leakage inductance, removing the compensation inductor from the secondary winding to obtain a reconfigured secondary winding, and adjusting a coupling coefficient between a primary winding of the VR inductor and the secondary winding to adjust the equivalent inductance, the adjusting of the coupling coefficient based on the removing of the compensation inductor.

Example 32 is at least one machine-readable medium including instructions that, when executed by processing circuitry, cause the processing circuitry to perform operations to implement any of Examples 1-31.

Example 33 is an apparatus comprising means to implement any of Examples 1-31.

Example 34 is a system to implement any of Examples 1-31.

Example 35 is a method to implement any of Examples 1-31.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. A voltage regulator (VR) apparatus comprising:
an input voltage terminal coupled to a plurality of input terminals of a corresponding plurality of power stage circuits;
a plurality of VR inductors, a first terminal of each of the plurality of VR inductors coupled to an output terminal of a corresponding power stage circuit of the plurality of power stage circuits; and
an output voltage terminal coupled to a second terminal of each of the plurality of VR inductors.

2. The VR apparatus of claim 1, wherein each VR inductor of the plurality of VR inductors comprises:
a primary leakage inductance comprising a first terminal coupled to the first terminal of the VR inductor.

3. The VR apparatus of claim 2, wherein each VR inductor of the plurality of VR inductors comprises:
a magnetizing inductance comprising a first terminal coupled to a second terminal of the primary leakage inductance and a second terminal coupled to the second terminal of the VR inductor.

4. The VR apparatus of claim 3, wherein each VR inductor of the plurality of VR inductors comprises:
a primary winding comprising a first terminal coupled to the second terminal of the primary leakage inductance and a second terminal coupled to the second terminal of the VR inductor.

5. The VR apparatus of claim 4, wherein each VR inductor of the plurality of VR inductors comprises:
a secondary winding comprising a first terminal coupled to a first terminal of a secondary leakage inductance.

6. The VR apparatus of claim 5, wherein a second terminal of the secondary winding is coupled in series with at least another secondary winding of at least another VR inductor of the plurality of VR inductors.

7. The VR apparatus of claim 6, wherein the primary winding is coupled in parallel with at least another primary winding of the at least another VR inductor of the plurality of VR inductors.

8. The apparatus of claim 7, comprising:
a system-on-chip (SoC), the SoC comprising an integrated circuit (IC), the IC comprising at least one of the input voltage terminal, the output voltage terminal, and one or more of the plurality of VR inductors.

9. The apparatus of claim 8, wherein the SoC further comprises at least one connector, and wherein the at least one connector conforms with at least one of a Universal Serial Bus (USB) specification, a High-Definition Multimedia Interface (HDMI) specification, a Thunderbolt specification, a Peripheral Component Interconnect Express (PCIe) specification, or an Ethernet specification.

10. A voltage regulator (VR) inductor, the VR inductor comprising:
at least one primary winding; and
at least one secondary winding inductively coupled to the at least one primary winding, the at least one secondary winding comprising leakage inductance, and one or both of the leakage inductance and a coupling coefficient of the VR inductor are configured based on an equivalent inductance of the at least another secondary winding when the at least one secondary winding includes a compensation inductor.

11. The VR inductor of claim 10, further comprising:
a first plurality of interconnects coupled to the at least one primary winding; and
a second plurality of interconnects coupled to the at least one secondary winding.

12. The VR inductor of claim 11, wherein one or more of the first plurality of interconnects couple the at least one primary winding of the VR inductor in parallel with at least another primary winding of at least another VR inductor.

13. The VR inductor of claim 12, wherein one or more of the second plurality of interconnects couple the at least one secondary winding of the VR inductor in series with at least another secondary winding of the at least another VR inductor.

14. The VR inductor of claim 10, wherein the coupling coefficient is configured to be below 0.95 and the leakage inductance is configured to be below 17 nH.

15. The VR inductor of claim 10, wherein the coupling coefficient is configured between 0.9 and 0.92 and the leakage inductance is configured between 14 and 17 nH.

16. A method for configuring a voltage regulator (VR) inductor, the method comprising:
determining a compensation inductance of a compensation inductor in a secondary winding of the VR inductor;
determining leakage inductance in the secondary winding;
determining an equivalent inductance of the secondary winding based on the compensation inductance and the leakage inductance;
reconfiguring the secondary winding based on removing the compensation inductor, to obtain a reconfigured secondary winding; and
adjusting a coupling coefficient between a primary winding of the VR inductor and the secondary winding to adjust the equivalent inductance, the adjusting of the coupling coefficient based on the removing of the compensation inductor.

17. The method of claim 16, further comprising:
adjusting the coupling coefficient based on a desired equivalent inductance of the reconfigured secondary winding.

18. The method of claim 16, further comprising:
adjusting the coupling coefficient based on a desired equivalent inductance of the reconfigured secondary winding being substantially equal to the equivalent inductance of the secondary winding prior to the reconfiguring.

19. The method of claim 16, wherein the VR inductor comprises a plurality of secondary windings including the secondary winding, the plurality of secondary windings associated with a corresponding plurality of leakage inductances, and the method further comprising:
adjusting the equivalent inductance further based on adjusting the leakage inductance of one or more of the plurality of leakage inductances.

20. The method of claim 16, wherein adjusting the equivalent inductance comprises:
adjusting the coupling coefficient to be below 0.95; and
adjusting the leakage inductance to be below 17 nH.
